(19) United States
(12) Patent Application Publication
(10) Pub. No.: US 2014/0333966 A1
(43) Pub. Date: Nov. 13, 2014

(54) METHOD FOR MANAGING A PLURALITY OF IMAGE PROCESSING DEVICES, COMPUTER-PROGRAM PRODUCT, FLEET MANAGEMENT SYSTEM, MOBILE DEVICE, AND MONITORING DEVICE THEREFOR

(71) Applicant: OCE-TECHNOLOGIES B.V., Venlo (NL)

(72) Inventor: Robertus P.E.H. HEEMELS, Roermond (NL)

(21) Appl. No.: 14/340,293

(22) Filed: Jul. 24, 2014

Related U.S. Application Data
(63) Continuation of application No. PCT/EP2013/051685, filed on Jan. 29, 2013.

(30) Foreign Application Priority Data
Jan. 31, 2012 (EP) 12153362.4

(51) Int. Cl. H04N 1/00

(52) U.S. Cl. CPC H04N 1/00029; H04N 1/00061; H04N 2201/0003
USPC 358/1.15

(57) ABSTRACT

The present invention relates to a method for managing a plurality of image processing devices, comprising the steps of: an image processing device sending a status update to a monitoring device, the monitoring device collecting status updates received from image processing devices; in response to a predetermined event generating a work list based on the collected status updates; sending the work list to a mobile device; and communicating the work list on the mobile device. In a specific embodiment generating the work list comprises: including from a predefined list of image processing devices, image processing devices for which a status has been received that signifies that the device requires attendance, either immediately or in the near future. In a more specific embodiment, it is determined that an image processing device requires attendance by comparing the status updates received from the image processing device to a predefined list of statuses for which it is known that the status signifies that attendance is required or not.

The present invention relates to a method for managing a plurality of image processing devices.

The present invention also relates to a computer-program product that executes such a method.

The present invention further relates to a fleet management system for managing a plurality of image processing devices.

The present invention also relates to a mobile device for such a fleet management system.

Furthermore, the present invention relates to a monitoring device for such a fleet management system.

### BACKGROUND OF THE INVENTION

In knowledge intensive and administrative environments a lot of documents are being processed. Such environments often rely heavily on image processing devices such as printers, scanners, copiers, faxes, and multi-functional devices, combining two or more of these devices. Managing a large number of image processing devices becomes a task in its own right, especially if the image processing devices are spread around one or more buildings.

Systems for monitoring a number of image processing devices are known, for example from the co-pending application EP 1426833 A2 by the present applicant. Although the known monitoring system helps an operator getting an overview of the status of all image processing devices, he might still be overwhelmed by status updates from all the image processing devices. This might result in the operator dedicating his time to solving acute problems and overlooking conditions that may soon result in acute problems. A simple example is the operator refilling paper at printers that are out of paper and overlooking other printers that are not out of paper yet, but are low on paper and might run out of paper soon.

The object of the present invention is to overcome this drawback.

### SUMMARY OF THE INVENTION

The present invention attains this object by providing a method for managing a plurality of image processing devices, comprising the steps of: an image processing device sending a status update to a monitoring device, the monitoring device collecting status updates received from image processing devices; in response to a predetermined event generating a work list based on the collected status updates; sending the work list to a mobile device; and communicating the work list on the mobile device. The image processing device communicates status messages to the monitoring device. The monitoring device collects the status updates from a plurality of image processing devices. Based on these status updates a work list is compiled for the operator that provides an overview of activities to be performed by the operator. The work list does not list every single status update from every single image processing device. Instead the list is filtered such that the operator is only provided with information regarding activities to be performed in order to bring image processing devices that can not proceed, back in operation, or to keep image processing devices in operation by performing precautionary actions. This way, the operator is not overwhelmed by information from maybe tens or hundreds of image processing devices. Furthermore, the work list is provided to the operator through a mobile device, allowing him to keep the overview while working in the field on the image processing devices. Especially if image processing devices are scattered over multiple buildings on a site, this is very advantageous, as the status of an image processing device may change while the operator is solving issues with another device. Instead of heading back to his desk to learn about the new incident, the work list is automatically updated and the operator's activities may immediately be rescheduled. Depending on the urgency of the new incident the work list may be updated in different ways. If the new incident has low priority, a new item is added to the work list in an appropriate position depending on the physical location of the image processing device in relation to the current location of the operator and/or the locations of image processing devices still to be visited according to the worklist in order to reduce the distance the operator has to travel while going through his work list. If the new incident has medium priority, it may be added to the work list as the next activity. Ultimately, if the incident has high priority, the operator may be immediately alerted by the mobile device and the operator may leave his current task unfinished in order to first attend to the new incident before returning to his current task. In a further example embodiment, the work list is communicated to the operator by means of a display provided on the mobile device.

According to a further aspect, the present invention provides a method, wherein generating the work list comprises including every image processing device that has a status that signifies that the image processing device requires attendance, either immediately or in the near future. This embodiment is specifically advantageous if the attendance required is local attendance by the operator, for example, dealing with a paper jam, or refilling paper. By including an image processing device, the operator is able to see what image processing devices he needs to visit. After he has attended to an image processing device, he can check in the work list what image processing device he should visit next.

Whether a status update requires attendance in the near future may in a specific embodiment be determined by a predefined period. This predefined period is either pre-set by the supplier of the fleet management system, or it is alternatively configurable by the operator. In a preferred embodiment this period differs for different categories of status updates. For example, paper might need to be refilled several times a day and a low paper status needs to be followed up within a period of minutes or tens of minutes. Exchanging a drum, however, is something that only occurs occasionally and might even require ordering from a supplier or from a central storage location. In this case a follow up within a couple of hours or even a couple of days might be acceptable. For choosing an appropriate period, one needs to take into account how much more time it will take before the status results in a new status that requires immediate attendance, how much time it will take to prepare to attend to the issue, and how much time will typically expire before the operator will attend the image processing device based on some predetermined schedule.

According to a further advantageous aspect, the present invention provides a method, wherein generating the work list comprises: including from a predefined list of image processing devices, image processing devices for which a status has been received that signifies that the device requires attendance, either immediately or in the near future. This method is specifically advantageous in larger sites where operators walk more or less predetermined routes to attend to image processing devices on a precautionary basis or where it is advantageous to define multiple routes, for example in different buildings or routes for different operators that work in parallel. For example, in a morning run the image processing devices in a first section of a building are attended to and provided with new supplies of paper, staples, etc., and in an afternoon run, the image processing devices in a second section of the building are dealt with. Based on the status updates received, image processing devices that do not need attendance are not included in the work list and therefore skipped by the operator. However, image processing devices that are not on the predefined list, but require immediate attendance might be included, although they would normally be attended to in another run based on the predefined lists.

In accordance with another aspect of the invention, generating the work list comprises: including from a predefined list of image processing devices, image processing devices irrespective of their status. This allows for entries in the work list for purely preventative actions that have not lead to a status that signals that attendance is required either now or in the near future, or for preventative actions that may not lead to such a status. An example of a preventative action that may not lead to such a status is cleaning the glass plate of a flatbed scanner.

The present invention further provides a method wherein it is determined that an image processing device requires attendance by comparing the status updates received from the image processing device to a predefined list of statuses for which it is known that the status signifies that attendance is required or not. A predefined list might be provided listing all statuses that do require attendance. Alternatively, a predefined list is provided that lists all statuses that do not require attendance. Again alternatively, a predefined list is provided with an additional field, which additional field specifies whether attendance is required or not.

According to another aspect, the present invention provides a method, wherein the work list further comprises a type of consumable required by the image processing device. This informs the operator about what he has to do at an image processing device, and it also tells him how much consumables he needs. Consumables include for example paper (of different types, such as different sizes, thickness, the presence of a coating), staples, toner, ink, but also supplies as for example drums or belts that require periodical replacement. The word require is to be read both in the strict sense (operation can not continue unless the consumable is refilled, for example a printer with no paper left can not print), and in a more loose sense, meaning operation can at least now continue, but this might change soon (for example paper is low in a printer) or operation can proceed but in some degraded mode (for example there are no staples left, but the printer can still print).

According to a further advantageous aspect, the present invention provides a method, wherein a status update comprises information on a remaining amount or used amount or required amount of consumables. This allows the operator to bring enough consumables on his run in order to refill all image processing devices. The amount may be specified in the number of individual items required, such as 200 sheets of paper, or in package such as 2 boxes of paper, or 1 package of staples.

According to a preferred aspect, the present invention provides a method, wherein the work list further comprises an amount of consumables of a type of consumables required by the image processing device. Again, the word require is to be read both in the strict sense, and in a more loose sense.

According to another preferred aspect, a method is provided, wherein the mobile device communicates a total number of consumables required by the image processing devices included in the work list. This allows the operator to immediately see how much of some type of consumable he needs to bring on his run. Again, the amount may be specified as individual items, or as number of packages.

The present invention further provides a method, wherein the predetermined event is at least one of: a status update having a priority exceeding a predetermined threshold; an operator manually invoking the generation of a work list; a number of status updates sharing a status category, the number exceeding a predetermined threshold; and a specific time occurring. A status update having a priority exceeding a predetermined threshold is useful for responding to urgent issues that immediately prevent an image processing device from operating. The number of status updates sharing a status category exceeding a predetermined number might help the operator by not sending him out when a single image processing device needs attendance while a device located near that device might serve the users in the meantime. Only when several devices are not operational, the issue might become problematic. Manually invoked work list generation and scheduled work list generation are typically useful for doing periodic precautionary runs, for example, for refilling paper when the printer has not run out yet, cleaning the glass of flatbed scanners, etc. The specific time may be a simple time, but may also include further time related information, for example the day of the week, or some specification like 2^{nd} Monday of the month.

According to another aspect, the present invention provides a method, wherein a status update exceeds a predetermined threshold, the method further comprising determining the location of the image processing device the status update originates from; determining the location of at least part of the mobile devices; determining the mobile device which location is closest to the location of the image processing device which status update exceeded the predetermined threshold; and including the status update in the work list for the closest mobile device. For status updates that require immediate attendance, the present invention is able to determine the operator that is the closest and update his work list in order to minimise the downtime of the faulty image processing device. The location of the mobile device may be determined through traditional methods, such as GPS location, actual connections to wireless communication stations such as WiFi access points, but also based on information entered by the operators, such as the location of the image processing device of the last resolved item in a work list or alternatively the current or subsequent item in a work list, or a work list the operator confirmed to be handling currently.

According to another aspect, the present invention provides a method for managing a plurality of image processing devices, comprising the steps of: a monitoring device collecting status updates received from image processing devices; in response to a predetermined event generating a work list based on the collected status updates; and sending the work list to a mobile device.

According to again another aspect of the present invention a method is provided for managing a plurality of image processing devices, comprising the steps of: receiving from a monitoring device a work list listing image processing devices that require attendance; and communicating the work list on the mobile device.

The present invention further provides a computer-program product that executes any of the methods as described above when executed on a processor.

According to another embodiment, the present invention provides a fleet management system for managing a plurality of image processing devices, comprising: a plurality of image processing devices comprising communication means for sending status updates; a monitoring device comprising communication means for receiving status updates from the plurality of image processing devices and storage means for storing received status updates; at least one mobile device comprising communication means for wirelessly communicating with the monitoring device; characterised by the monitoring device comprising work list determination means for generating a list of image processing devices that require attendance.

In a specific embodiment, the present invention provides a mobile device as described above with regard to the provided fleet management system, which mobile device is arranged to execute any of the above described methods.

According to another embodiment, the present invention provides a monitoring device as described with regard to the provided fleet management system, which monitoring device is arranged to execute any of the above described methods.

### BRIEF DESCRIPTION OF THE DRAWINGS

Further embodiments and advantages are described below with reference to the appended figures wherein:

FIG. 1 a diagram shows of an embodiment of a system according to the present invention; and

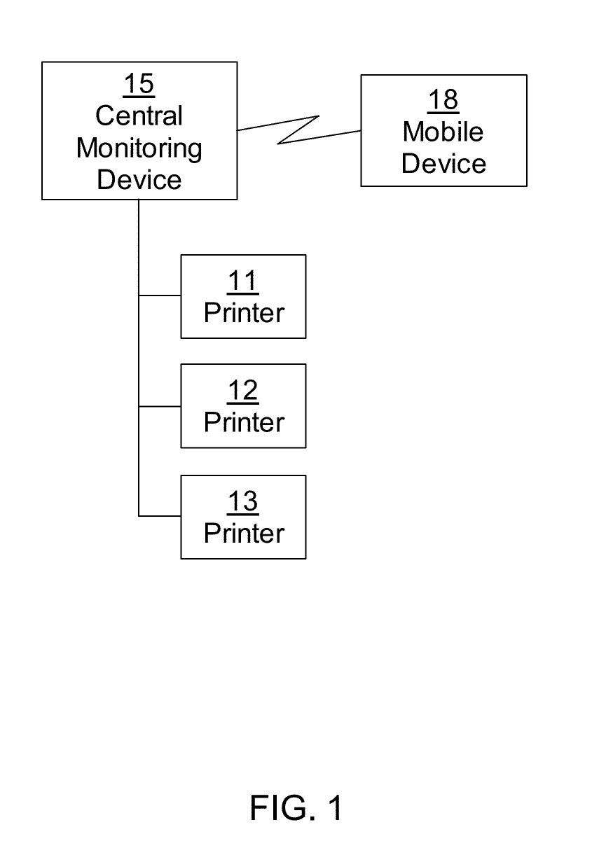

FIG. 2 an embodiment of the user interface in accordance with the present invention.

### DETAILED DESCRIPTION OF THE DRAWINGS

A typical system according to the present invention comprises a number of printers 11, 12, 13. These printers are connected through a network to a monitoring device 15. The printers 11, 12, and 13 send status updates to the monitoring device 15. Typical status updates comprise information on errors that occurred, warnings raised and other alerts. For example, the printers 11, 12, 13 communicate the number of paper sheets left in the paper trays, paper low warnings, out-of-paper errors, toner low warnings, out-of-toner errors, paper jam errors, etc. The monitoring device 15 collects these status updates. Based on these status updates, the monitoring device 15 compiles one or more work lists. A work list is assigned to an operator in order to resolve the issues on the work list. The work list may be generated on request, or scheduled, or triggered by some status update exceeding a predetermined priority threshold. The work list is sent to a mobile device 18 carried by the operator the work list is assigned to. Sending the work list to the mobile device 18 comprises pull technology, but might alternatively also comprise push technology or a combination thereof. For example at the start of a work day, the mobile device 18 requests the work list (pull request) from the monitoring device 15. During the day, updates to the work list are pushed by the monitoring device 15 to the mobile device 18.

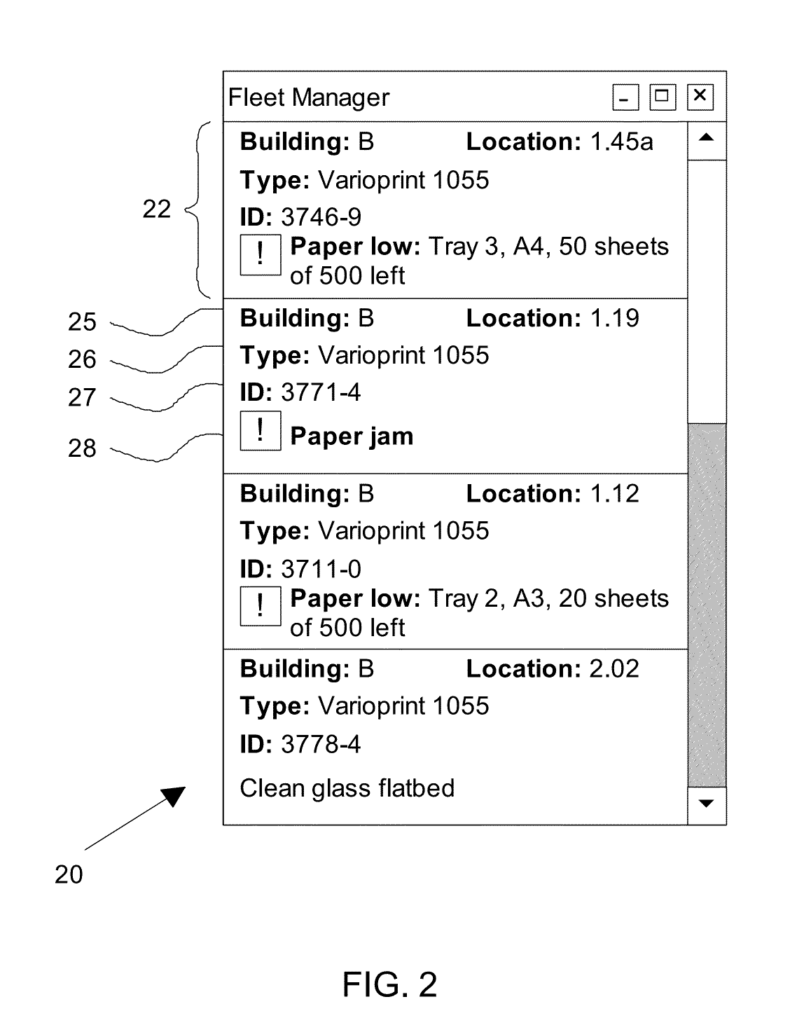

The mobile device 18 displays (FIG. 2) the work list 20 on its display. The work list comprises a number of records 22. Every record 22 shows a location 25 of the image processing device 11, 12, 13, the type of device 26, an identifier 27, and a message 28 informing the operator what action is required. In the example shown two printers are low on paper and need the paper trays to be refilled. One of the printers requires A4 size paper, the other A3 size paper. The operator can see how much paper is left, and how much the trays can hold. Another printer is experiencing a paper jam. The last printer shown only requires precautionary action, namely the glass of the flatbed scanner is to be cleaned. This later task is a typical scheduled task to keep the devices in proper order.

In a more advanced example, the mobile device 18 shows a map of the building with the location of the next image processing device requiring attendance.

A further improvement is that the mobile device 18 includes some identification hardware to identify the image processing device the operator is attending to. This is an alternative for the operator manually checking off the record in the work list, or the fleet management system receiving a status from the image processing device that all issues are resolved. As an example, the image processing devices may be provided with optical tags, such as barcodes or QR-codes, that are scanned by the mobile device 18. This way, the operator can easily inform the system that he is at the proper location. This facilitates reporting back to the system that work has started on the current issue, and later that the current issue has been resolved. An alternative to optical tags is identification through radio, for example RFID-tags or based on Bluetooth or Near Field Communication technology. This also allows the operator to report back to the system what actions he has performed at a specific image processing device, such as “loaded 1000 sheets of A4”.

It should be clear to the person skilled in the art that various adaptations and modifications are possible within the scope of the present invention. For example, it is possible to combine two or more embodiments and create a further embodiment which is still within the scope of the present invention. Furthermore, the examples given and the figures provided are only to illustrate the present invention and should not be regarded as limiting the scope of the present invention. The scope of protection sought is only limited by the following claims.

1. A method for managing a plurality of image processing devices, comprising the steps of:
an image processing device of the plurality of image processing devices sending a status update to a monitoring device;
the monitoring device collecting status updates received from the plurality of image processing devices;
in response to a predetermined event generating a work list based on the collected status updates;
sending the work list to a mobile device; and
communicating the work list on the mobile device.

2. The method according to claim 1, wherein generating the work list comprises:
including, from a predefined list of image processing devices, image processing devices for which a status has been received that signifies that the device requires attendance, either immediately or in the near future.

3. The method according to claim 1, further comprising the step of determining that an image processing device requires attendance by comparing the status updates received from the image processing device to a predefined list of statuses for which it is known that the status signifies that attendance is required or not.

4. The method according to claim 1, wherein the work list further comprises a type of consumable required by the image processing device.

5. The method according to claim 1, wherein a status update comprises information on a remaining amount or used amount or required amount of consumables.

6. The method according to claim 1, wherein the work list further comprises an amount of consumables of a type of consumables required by the image processing device.

7. The method according to claim 1, wherein the mobile device communicates a total number of consumables required by the image processing devices included in the work list.

8. The method according to claim 1, wherein the predetermined event is at least one of:
a status update having a priority exceeding a predetermined threshold;
an operator manually invoking the generation of a work list;
a number of status updates sharing a status category, the number exceeding a predetermined threshold; and
a specific time occurring.

9. A method for managing a plurality of image processing devices, comprising the steps of:
a monitoring device collecting status updates received from the plurality of image processing devices;
in response to a predetermined event,, generating a work list based on the collected status updates; and
sending the work list to a mobile device.

10. A method for managing a plurality of image processing devices, comprising the steps of:
receiving from a monitoring device a work list listing image processing devices that require attendance; and
communicating the work list on the mobile device.

11. A computer-program product embodied on a non-transitory computer readable medium and configured to execute the method according to claim 1 when executed on a processor.

12. A non-transitory data carrier having stored thereon the computer-program product according to claim 11.

13. A fleet management system for managing a plurality of image processing devices, comprising:
a plurality of image processing devices comprising a communication device configured to send status updates;
a monitoring device comprising a communication device configured to receive status updates from the plurality of image processing devices and a storage device for storing received status updates; and
at least one mobile device comprising a communication device configured to wirelessly communicate with the monitoring device,
wherein the monitoring device comprises a work list determination device configured to generate a list of image processing devices that require attendance.

14. A mobile device comprising a communication device configured to wirelessly communicate with a monitoring device and arranged to execute the method according to claim 1.

15. A monitoring device comprising a communication device configured to receive status updates from a plurality of image processing devices and a storage device for storing received status updates and arranged to execute the method according to claim 1.

16. The method according to claim 2, further comprising the step of determining that an image processing device requires attendance by comparing the status updates received from the image processing device to a predefined list of statuses for which it is known that the status signifies that attendance is required or not.

17. The method according to claim 2, wherein the work list further comprises a type of consumable required by the image processing device.

18. The method according to claim 3, wherein the work list further comprises a type of consumable required by the image processing device.

19. The method according to claim 2, wherein a status update comprises information on a remaining amount or used amount or required amount of consumables.

20. The method according to claim 3, wherein a status update comprises information on a remaining amount or used amount or required amount of consumables.
